(19) United States
(12) Patent Application Publication
(10) Pub. No.: US 2024/0102505 A1
(43) Pub. Date: Mar. 28, 2024

(54) INSERT NUT

(71) Applicant: IWATA BOLT KABUSHIKI KAISHA, Tokyo (JP)

(72) Inventor: Kenta TASAKA, Tokyo (JP)

(73) Assignee: IWATA BOLT KABUSHIKI KAISHA, Tokyo (JP)

(21) Appl. No.: 18/236,986

(22) Filed: Aug. 23, 2023

(30) Foreign Application Priority Data
Sep. 27, 2022 (JP) 2022-003196

(51) Int. Cl. F16B 37/04; F16B 37/14

(52) U.S. Cl. CPC F16B 37/048; F16B 37/14

(57) ABSTRACT

An insert nut in which one end of a through hole with an internal thread is sealed is provided. An insert nut to be embedded in a resin molded product includes: a nut body having a through hole with an internal thread, and a peripheral wall formed on one side of the through hole; and a cap fitted in the peripheral wall of the nut body. A proximal part is formed on a proximal end of the peripheral wall of the nut body. The cap is pressure-bonded and fixed between the proximal part and the peripheral wall through a part thereof that is bent inside the through hole. The peripheral wall is pressure-bonded to the cap such that a distal end surface of the peripheral wall is in contact with the cap.

### FIELD OF THE INVENTION

The present disclosure relates to an insert nut.

### BACKGROUND ART

An insert nut to be embedded in a resin molded product has been conventionally developed. Such an insert nut allows a threaded member having an external thread to be tightened to an internal thread formed in a hole of the insert nut embedded in the resin molded product.

An insert nut in which a hole with an internal thread is a through hole may cause various problems. For example, water or other substances could enter the through hole. In addition, a foreign matter on the insert nut or the threaded member could fall through the through hole from a side opposite to a side where the threaded member having an external thread is inserted, affecting the surrounding area. Thus, the insert nut has been desired to be a cap nut which is a nut through which a hole does not pass.

The following method can be considered for manufacturing an insert nut through which a hole does not pass. Namely, a hole is formed in a member which will serve as an insert nut in such a manner that a bottom remains in the hole in order not that the hole becomes a through hole. Then, the hole is tapped to form therein an internal thread in such a manner that a bottom remains in the hole in order not that the hole becomes a through hole. However, since this method requires the forming process and the tapping process of the hole to be carefully and cautiously performed such that the bottom remains in the hole, the manufacturing efficiency of the insert nut is low. Also, this method forms an incomplete threaded portion, in which the internal thread has a thread that is not large enough, on the bottom side of the hole. Thus, it is necessary to secure an area where the thread of the internal thread is large enough, in consideration that the incomplete threaded portion is formed. This disadvantageously enlarges a size of the insert nut in a direction along which the hole extends. The enlargement in size of the insert nut in a direction along which the hole extends increases the manufacturing cost of the insert nut. In addition, the enlargement in size of the insert nut in a direction along which the hole extends decreases the degree of freedom in the shape of the resin molded product in which the insert nut is to be embedded.

As disclosed in JP Utility Model Registration No. 3144885, for example, as a method of manufacturing an insert nut through which a hole does not pass, another method in which a through hole is formed as a hole in a body of an insert nut, and a cap is fitted in one end of the through hole is known. JP Utility Model Registration No. 3144885 particularly describes as follows. A cap is fitted in an annular recess provided in an upper end surface of the nut body, and the cap is pressure-bonded to a periphery of the recess so that the cap is integrally joined to the nut body. Thus, an insert nut through which a hole does not pass can be completed.

### SUMMARY OF THE INVENTION

In an insert nut manufactured by fitting a cap in one end of a through hole of a nut body with an internal thread, it is sometimes required that the one end of the through hole is more stably sealed by the cap. For example, when a resin molded product in which an insert nut is embedded is manufactured, a resin forming the resin molded product could enter the through hole. In particular, when some or all of the resin forming the resin molded product is melted in order to manufacture the resin molded product in which the insert nut is embedded, the molten resin could enter the through hole. In this case, in order to restrict the resin from entering the through hole, the one end of the through hole may be required to be more stably sealed by the cap.

The present disclosure has been made in view of the above circumstances. An object of the present invention is to provide an insert nut in which one end of a through hole with an internal thread is sealed.

A first embodiment of the present disclosure is an insert nut to be embedded in a resin molded product, the insert nut comprising:
a nut body having a through hole with an internal thread, and a peripheral wall formed on one side of the through hole; and
a cap fitted in the peripheral wall of the nut body;
wherein:
a proximal part is formed on a proximal end of the peripheral wall of the nut body;
the cap is pressure-bonded and fixed between the proximal part and the peripheral wall through a part thereof that is bent inside the through hole;
   and
the peripheral wall is pressure-bonded to the cap such that a distal end surface of the peripheral wall is in contact with the cap.

A second embodiment of the present disclosure is an insert nut to be embedded in a resin molded product, the insert nut comprising:
a nut body having a through hole with an internal thread, and a peripheral wall formed on one side of the through hole; and
a cap fitted in the peripheral wall of the nut body;
wherein:
a proximal part is formed on a proximal end of the peripheral wall of the nut body;
the cap is pressure-bonded and fixed between the proximal part and the peripheral wall through a part thereof that is bent inside the through hole;
   and
the peripheral wall is pressure-bonded to the cap such that a side surface of the peripheral wall is in contact with the cap.

A third embodiment of the present disclosure is such that, in the insert nut according to the aforementioned first embodiment or the aforementioned second embodiment, the peripheral wall may be pressure-bonded to the cap to cover an entire circumference of an outer edge of the cap.

A fourth embodiment of the present disclosure is such that, in the insert nut according to the aforementioned first embodiment to the aforementioned third embodiment, each of a contact part of the cap, which is in contact with the peripheral wall, and a contact part of the cap, which is in contact with the proximal part, may have a part that is inclined upward as it extends outside.

A fifth embodiment of the present disclosure is such that, in the insert nut according to the aforementioned first embodiment to the aforementioned fourth embodiment, the proximal part may have an irregular shape breaking into the cap.

A sixth embodiment of the present disclosure is such that, in the insert nut according to the aforementioned first embodiment to the aforementioned fifth embodiment, the cap may have a cap body, and a seal member provided between the nut body and the cap body, and the cap may be in contact with the nut body through the seal member.

A seventh embodiment of the present disclosure is such that, in the insert nut according to the aforementioned first embodiment to the aforementioned sixth embodiment, the nut body may be made of carbon steel and plated with zinc, or may be made of stainless steel.

An eighth embodiment of the present disclosure is such that, in the insert nut according to the aforementioned first embodiment to the aforementioned seventh embodiment, the cap body may be made of stainless steel or aluminum alloy.

The present disclosure can provide an insert nut in which one end of a through hole with an internal thread is sealed.

### BRIEF DESCRIPTION OF THE DRAWINGS

FIG. 1 is a perspective view showing an example of an insert nut according to a first embodiment.

FIG. 2 is a side and sectional view showing the example of the insert nut according to the first embodiment.

FIG. 3 is a partial sectional view of the example of the insert nut according to the first embodiment.

FIG. 4 is a sectional view showing an example of a resin molded product according to the first embodiment.

FIG. 5 is a perspective showing an example of an insert nut according to a second embodiment.

FIG. 6 is a side and sectional view showing the example of the insert nut according to the second embodiment.

FIG. 7 is a partial sectional view of the example of the insert nut according to the second embodiment.

FIG. 8 is a perspective view showing an example of an insert nut according to a first modification example.

FIG. 9 is a side and sectional view showing the example of the insert nut according to the first modification example.

FIG. 10 is a partial sectional view showing the example of the insert nut according to the first modification example.

FIG. 11 is a perspective view showing the example of the insert nut according to the first modification example.

FIG. 12 is a side and sectional view showing the example of the insert nut according to the first modification example.

FIG. 13 is a partial sectional view showing the example of the insert nut according to the first modification example.

FIG. 14 is a perspective view showing an example of an insert nut according to a second modification example.

FIG. 15 is a side and sectional view showing the example of the insert nut according to the second modification example.

FIG. 16 is a partial sectional view showing the example of the insert nut according to the second modification example.

### DETAILED DESCRIPTION OF THE INVENTION

### First Embodiment

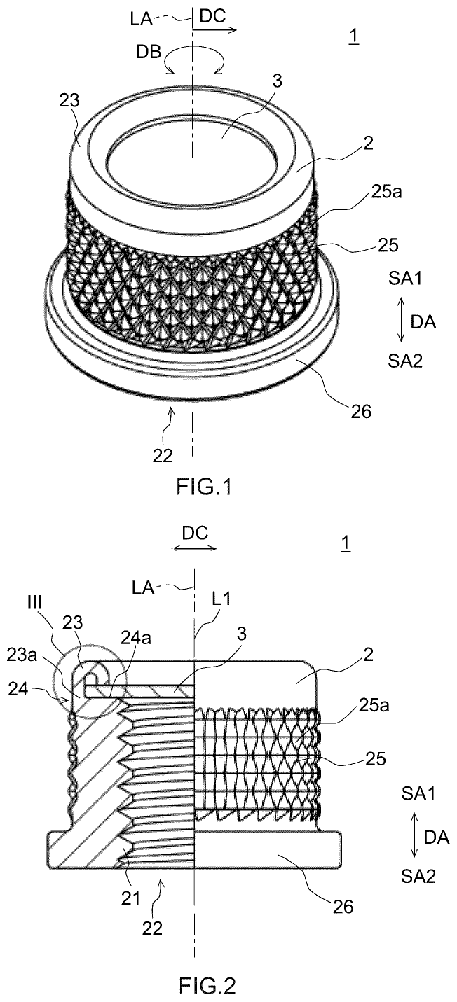

An insert nut 1 in a first embodiment of the present disclosure is described first with reference to FIGS. 1 to 4. The insert nut 1 in the first embodiment is the insert nut 1 to be embedded in a resin molded product 7 described later.

FIG. 1 is a perspective view showing an insert nut 1 in a first embodiment. FIG. 2 is a side and sectional view of the insert nut 1 shown in FIG. 1. In FIG. 2, a right side of a line indicated by a reference numeral L1 shows a side view of a right half of the insert nut 1. A left side of the line indicated by the reference numeral L1 shows a sectional view of a left half of the insert nut 1. As shown in FIGS. 1 and 2, the insert nut 1 comprises: a nut body 2 having a through hole 22 with an internal thread 21, and a peripheral wall 23 formed on one side of the through hole 22; and a cap 3 fitted in the peripheral wall 23 of the nut body 2. A proximal part 24 is formed on a proximal end 23a of the peripheral wall 23 of the nut body 2. In the insert nut 1, the cap 3 is pressure-bonded and fixed between the proximal part 24 and the peripheral wall 23 through a part thereof that is bent inside the through hole 23.

When a threaded member having an external thread, such as a common bolt, is tightened to the internal thread 21, the insert nut 1 is relatively rotated with respect to the threaded member around an axis line LA. A direction of the axis line LA is referred to as an axial direction DA. A direction around the axis line LA is referred to as circumferential direction DB. A direction orthogonal to the axis line LA is referred to as radial direction DC. One side of the axial direction DA, on which the cap is fitted in the through hole 22 of the insert nut 1, is referred to as a first side SA1, and the other side of the axial direction DA, which is opposite to the first side SA1, is referred to as a second side SA2. One side of the radial direction DC, which is toward the axis line LA, is referred to as inside, and the other side of the radial direction DC, which is away from the axis line LA, is referred to as outside.

Next, respective constituent elements of the insert nut 1 are further described.

The nut body 2 is described first. The nut body 2 is a part that has the through hole 22 with the internal thread 21. In the example shown in FIG. 2, the nut body 2 has the through hole 22 extending in the axial direction DA, and the internal thread 21 is provided in an inner wall of the through hole 22. The nut body 2 has substantially a cylindrical shape around the axis line LA. The nut body 2 has substantially a cylindrical irregular part 25 having an irregular surface 25a on a side surface thereof, and a flange 26 provided on an end of the irregular part 25 on the second side SA2. The flange 26 has a flat ring-like shape that encloses the axis line LA from outside the redial direction DC.

As described above, the nut body 2 has the peripheral wall 23 formed on one side (first side SA1) of the through hole 22. In addition, the nut body 2 has the proximal part 24 formed on the proximal end 23a of the peripheral wall 23. The proximal part 24 is a part where the cap 3 fitted in the peripheral wall 23 is placed. In the example shown in FIG. 2, the proximal part 24 has a placement surface 24a on which the cap 3 fitted in the peripheral 23 is placed. The through hole 22 passes through the placement surface 24a of the proximal part 24. The peripheral wall 23 is formed on the first side SA1 of the irregular part 25. The proximal part 24 is formed on the side of the proximal end 23a which is an end of the peripheral wall 23 on the second side SA2. In other words, the end of the irregular part 24 on the first side SA1 serves as the proximal part 24, and the peripheral wall 23 extends from the proximal part 24 to the first side SA1. In the example shown in FIG. 2, the peripheral wall 23 extends to the first side SA1 from the outside in the radial direction DC of a part which form the placement surface 24a of the proximal part 24. In the example shown in FIGS. 1 and 2, the peripheral wall 23 has an annular shape and surrounds the placement surface 24a of the proximal part 24 from the outside in the radial direction DC.

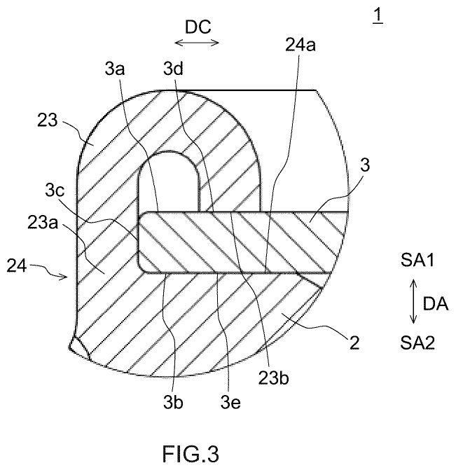

FIG. 3 is a partial sectional view showing in enlargement a part surrounded by a line indicted by a reference numeral III in FIG. 2. As shown in FIG. 3, the peripheral wall 23 is bent inside the through hole 22 (inside in the radial direction DC). Since the peripheral wall 23 is bent, the cap 3 is pressure-bonded and fixed between the proximal part 24 and the peripheral wall 23 through the bent part thereof.

A material of the nut body 2 is a metal material similar to a material of a common nut, for example. The nut body 2 is made of, for example, carbon steel, and is plated with zinc. The nut body 2 may be made of stainless steel.

Next, the cap 3 is described. The cap 3 is a member that is fitted in the peripheral wall 23 of the nut body 2. In the first embodiment, the cap 3 is a circular plate-like shape seen from the axial direction DA. The cap 3 has a first surface 3a located on the first side SA1, and a second surface 3b located on the second side SA2. In the first embodiment, the first surface 3a and the second surface 3b are flat surfaces. The first surface 3a and the second surface 3b are surfaces perpendicular to the axial direction DA. The cap 3 is in contact with the peripheral wall 23 through the first surface 3a, and is in contact with the proximal part 24 through the second surface 3b. An outside end of the cap 3 in the radial direction DC is referred to as outer edge 3c of the cap 3.

In the first embodiment, a part of the cap 3, which is in contact with the peripheral wall 23, and a part of the cap 3, which is in contact with the proximal part 24, are flat. In particular, the contact part of the cap 3, which is in contact with the peripheral wall 23, and the contact part of the cap 3, which is in contact with the proximal part 24, form flat surfaces perpendicular to the axial direction DA. In the example shown in FIG. 3, a first cap contact surface 3d of the cap 3, which is in contact with the peripheral wall 23, and a second cap contact surface 3e of the cap 3, which is in contact with the proximal part 24, are flat surfaces perpendicular to the axial direction DA.

A material of the cap 3 is a metal material similar to a material of a common nut, for example. The material of the cap 3 may differ from the material of the nut body 2. The cap 3 may comprise stainless steel or aluminum alloy. In the first embodiment, the cap 3 is a member made of a single material. In this case, the cap 3 may comprise stainless steel. Alternatively, the cap 3 may comprise aluminum alloy.

As described above, the cap 3 is pressure-bonded and fixed between the proximal part 24 and the peripheral wall 23 through the part thereof that is bent inside the through hole. Since the cap 3 is fixed to the nut body 2, one end (first side SA1) of the through hole 22 can be sealed by the cap 3.

An example of an aspect in which one end of the through hole 22 is sealed by the cap 3 in the first embodiment is described. In the first embodiment, since the peripheral wall 23 is bent inside the through hole 22, a surface of the peripheral wall 23 is in surface contact with the first surface 3a of the cap 3. In addition, the placement surface 24a of the proximal part 24 is in surface contact with the second surface 3b of the cap 3.

In the first embodiment, the peripheral wall 23 is pressure-bonded to the cap 3 to cover an entire circumference of the outer edge 3c of the cap 3. As described above, since the peripheral wall 23 has an annular shape and surrounds the placement surface 24a of the proximal part 24 from the outside in the radial direction DC, the peripheral wall 23 can be pressure-bonded to the cap 3 to cover the entire circumference of the outer edge 3c of the cap 3.

In the insert nut 1 in the first embodiment, the peripheral wall 23 is pressure-bonded through its distal end surface 23b to the cap 3. In the example shown in FIG. 3, the peripheral wall is bent at an angle of 180°. Thus, the peripheral wall 23 is pressure-bonded to the cap 3 such that the distal end 23b is in contact with the cap 3.

According to the first embodiment, since the peripheral wall 23 is pressure-bonded to the cap 3 such that the distal end surface 23b is in contact with the cap 3, one end of the through hole 22 is stably sealed by the cap 3. Particularly in the first embodiment, the distal end surface 23b of the peripheral wall 23 is in surface contact with the first surface 3a of the cap 3. This allows the distal end surface 23b of the peripheral wall 23 and the first surface 3a of the cap 3 to be in tight contact with each other, whereby the one end of the through hole 22 can be stably sealed. In addition, a pressing force toward the second side SA2 can be applied from the peripheral wall 23 to the first surface 3a of the cap 3. In particular, since the peripheral wall 23 is bent at an angle of 180° and the peripheral wall 23 is pressure-bonded to the cap 3 such that the distal end surface 23b is in contact with the cap 3, the pressing force from the peripheral wall 23 toward the second side SA2 can be made stronger. This allows the distal end surface 23b of the peripheral wall 23 and the first surface 3a of the cap 3 to be in tight contact with each other by the pressing force from the peripheral wall 23, whereby the one end of the through hole 22 can be stably sealed. When a below-described resin molded product 7 in which the insert nut 1 is embedded is manufactured, such an insert nut 1 in which the one end of the through hole 22 is stably sealed can restrict a resin forming the resin molded product 7 from entering the through hole 22.

According to the first embodiment, the peripheral wall 23 is pressure-bonded to the cap 3 to cover the entire circumference of the outer edge 3c of the cap 3. In particular, when seen from above (first side SA1 in the axial direction DA), the peripheral wall 23 is pressure-bonded to the cap 3 to cover the entire circumference of the outer edge 3c of the cap 3. This allows the distal end surface 23b of the peripheral wall 23 and the first surface 3a of the cap 3 to be in tight contact with each other in the entire circumference of the outer edge 3c of the cap 3, whereby the one end of the through hole 22 can be stably sealed.

In the first embodiment in which the nut body 2 is made of carbon steel and is plated with zinc, a product unit cost of the insert nut 1 can be reduced as compared with a case in which the nut body 2 is formed of another material. When the nut body 2 is made of stainless steel, generation of rust on the nut body 2 can be effectively restrained. From the viewpoint of reducing the product unit price, the nut body 2 made of carbon steel and plated with zinc is preferred to the nut body 2 made of stainless steel. On the other hand, when a conventional insert nut without through hole 22, e.g., a conventional cap nut is manufactured by plating with a carbon steel material with zinc, the following problem arises. Namely, it is difficult to plate an interior of the hole, in which the internal thread is formed, with zinc, because the plating liquid is difficult to enter the hole. In contrast, in the insert nut 1 in the first embodiment, the through hole 22 is formed in the nut body 22. Thus, it is easy to plate the inner wall of the through hole 22, in particular, a part of the inner wall of the through hole 22, in which the internal thread 21 is formed, by letting the plating liquid into the through hole 22.

In the first embodiment, since the cap 3 includes stainless steel, in particular, when the cap 3 purely comprises stainless steel, rust-proofing effect of the cap 3 increases. Namely, generation of rust on the cap 3 can be effectively restrained. Stainless steel is relatively a high-cost material compared to other materials. The cap 3 has a smaller volume and a simpler structure than the nut body 2. An increase in manufacturing cost of the insert nut 1 in which the cap 3 is made of stainless steel is smaller than an increase in manufacturing cost of the insert nut 1 in which the nut body 2 is made of stainless steel. Thus, it can be said that using stainless steel of the cap 3 is more cost effective than using stainless steel of the nut body 2. In addition, when the cap 3 includes aluminum alloy, in particular, when the cap 3 purely comprises aluminum alloy, tight contact between the cap 3 and the proximal part 24 and tight contact between the cap 3 and the peripheral wall 23 can be increased in a part where the cap 3 is pressure-bonded and fixed between the proximal part 24 and the peripheral wall 23.

### (Manufacturing Method of Insert Nut)

Next, a manufacturing method of the insert nut 1 as structured above is described.

The manufacturing method of the insert nut 1 is carried out as follows. A member from which the nut body 2 is originated is prepared, the member having parts corresponding to the irregular part 25 having the proximal part 24 on the end on the first side SA1, the flange 26 provided on the end of the irregular part 25 on the second side SA2, and the peripheral wall 23 extending from the proximal part 24 to the first side SA1 as described above. Then, the through hole 22 is formed in the member, and the through hole 22 is tapped so as to form the internal thread 21 in the inner wall of the through hole 22. Then, the cap 3 is placed in the peripheral wall 23 on the placement surface 24a of the proximal part 24. Then, the peripheral wall 23 is bent inside the through hole 22, and the cap 3 is pressure-bonded and fixed between the proximal part 24 and the peripheral wall 23 through its bent part. Thus, the cap 3 is fit and fixed in one end of the through hole 22, and the insert nut 1 in the first embodiment is manufactured.

As described above, the insert nut 1 in the first embodiment is manufactured by forming the through hole 22, by tapping the through hole 22 to form the internal thread 21 in the inner wall of the through hole 22, and by fitting the cap 3 in one end of the through hole 22. Thus, during the tapping process, for example, when a tap is inserted into the through hole 22 from one end in a direction along which the through hole 22 extends to form the internal thread 21, chips generated by the tapping process are discharged from a side opposite to the side into which the tap is inserted. Namely, chips generated when the through hole 22 is formed and when the through hole 22 is tapped to form the internal thread 21 in the inner wall of the through hole 22 are discharged from the through hole 22, chips rarely remain around the internal thread 21. The aforementioned manufacturing method can manufacture the insert nut 1 in which one end of the through hole 22 is sealed at a lower cost than a method in which a cap is attached by welding to one end of the through hole 22, for example. Namely, the insert nut 1 in the first embodiment can be manufacture by a lower cost manufacturing method.

When the nut body 2 is particularly formed by plating carbon steel with zinc, as described above, the manufacturing method of the insert nut 1 can be carried out as follows. A member made of carbon steel is prepared, the member having parts corresponding to the irregular part 25 having the proximal part 24 on the end on the first side SA1, the flange 26, and the peripheral wall 23. Then, the through hole 22 is formed in the member, and the through hole 22 is tapped to form the internal thread 21 in the inner wall of the though hole 22. Then, the member is plated with zinc. Thereafter, the cap 3 is placed in the peripheral wall 23 on the placement surface 24a of the proximal part 24, and the peripheral wall 23 is bent inside the through hole 22. Thereafter, the cap 3 is pressure-bonded between the proximal part 24 and the peripheral wall 23 through the bent part thereof. Such a manufacturing method allows the inner wall of the through hole 22, in particular, a part of the inner wall of the through hole 22, in which the internal thread 21 is formed, with zinc. Namely, it is easy to plate the inner wall of the through hole 22 of the insert nut 1 in the first embodiment, in particular, a part of the inner wall of the through hole 22, in which the internal thread 21 is formed, with zinc.

### (Manufacturing Method of Resin Molded Product)

Next, a method of manufacturing a resin molded product 7 in which the insert nut 1 is embedded, using the insert nut 1 as structured above, is described.

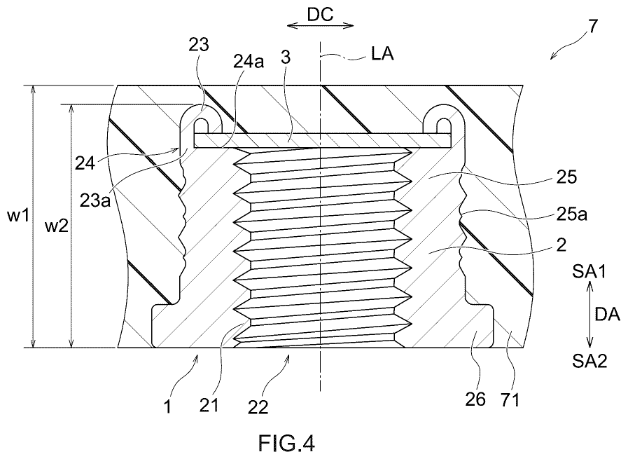

FIG. 4 is a sectional view showing a resin molded product 7 in which an insert nut 1 is embedded, which is manufactured by using the insert nut 1 in the first embodiment. In the example shown in FIG. 4, the resin molded product 7 comprises a resin part 71 made of a resin material, and the inset nut 1 embedded in the resin part 71. By way of example, the resin molded product 7 has substantially a plate-like shape, and the insert nut 1 is embedded in the resin part 71, with the axial direction DA corresponding to a thickness direction of the resin molded product 7. In the example shown in FIG. 4, recesses of the irregular surface 25a of the insert nut 1 are filled with the resin part 71. This restricts the insert nut 1 from being pulled out of the resin part 71. In addition, when a threaded member having an external thread is tightened to the internal thread 21, rotation of the insert nut 1 with respect to the resin part 71 is restricted.

In the example shown in FIG. 4, a thickness w1 of the resin molded product 7 (a dimension of the resin molded product 7 in the axial direction DA of the embedded insert nut 1) is larger than a dimension w2 of the insert nut 1 in the axial direction DA. Thus, the resin part 71 is located on the first side SA1 of the insert nut 1. In the example shown in FIG. 4, the insert nut 1 is covered with the resin part 71 on the outside in the radial direction DC and on the first side SA1 in the axial direction DA.

Since the insert nut 1 is embedded in the resin molded product 7 shown in FIG. 4, a threaded member having an external thread, such as a common bolt, can be tightened to the internal thread 21 of the insert nut 1.

The resin molded product 7 shown in FIG. 4 can be manufactured by integrally molding the insert nut 1 and the resin part 71. The resin molded product 7 can be manufactured by molding first the resin part 71 having a hole into which the insert nut 1 will be press-fitted, and then by press-fitting the inset nut 1 to the hole of the resin part 71. When the insert nut 1 is press-fitted to the hole of the resin part 71, so-called thermal press-fitting can be performed. Namely, heat may be applied to a vicinity of the hole of the resin part 71 to partially melt the vicinity of the hole of the resin part 71.

In the insert nut 1 in the first embodiment, the cap 3 is fitted in one end of the through hole 22, as described above. Since the cap 3 is pressure-bonded and fixed between the proximal part 24 and the peripheral wall 23 through a part thereof that is bent inside the through hole 22. Thus, one end of the through hole 22 is sealed by the cap 3. This restricts a resin forming the resin part 71 of the resin molded product 7 from entering the through hole 22, when the resin molded product 7 in which the insert nut 1 is embedded is manufactured. Particularly when some or all of the resin forming the resin molded product is melted in order to manufacture a resin molded product in which the insert nut 1 is embedded, the molten resin can be restricted from entering the through hole 22. A case in which all of the resin forming the resin molded product is melted in order to manufacture a resin molded product in which the insert nut 1 is embedded may be a case in which the interest nut 1 and the resin part 71 are integrally molded, as described above. A case in which some of the resin forming the resin molded product is melted in order to manufacture a resin molded product in which the insert nut 1 is embedded may be a case in which the insert nut 1 is thermally press-fitted into the hole of the resin part 71.

Particularly when the thickness w1 of the resin molded product 7 to be manufactured is larger than the dimension w2 of the insert nut 1, it is necessary to place a resin on the first side SA1 of the insert nut 1 during the manufacturing process of the resin molded product 7. Particularly when the resin molded product 7 is manufactured by integral molding, it is necessary to place a molten resin on the first side SA1 of the insert nut 1 during the manufacturing process of the resin molded product 7. Also in this case, the insert nut 1 in the first embodiment can restrict the molten resin from entering the through hole 22.

### Second Embodiment

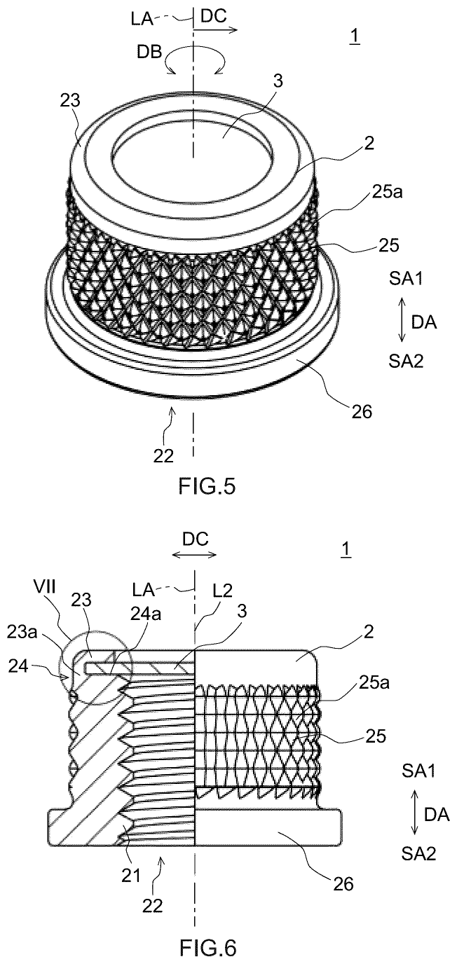

FIG. 5 is a perspective view showing an insert nut 1 in a second embodiment of the present disclosure. FIG. 6 is a side and sectional view of the insert nut 1 shown in FIG. 5. In FIG. 6, a right side of a line indicted by a reference numeral L2 shows a side view of a right half of the insert nut 1. A left side of the line indicated by the reference numeral L2 shows a sectional view of a left half of the insert nut 1. Similarly to the first embodiment, the insert nut 1 in the second embodiment comprises: a nut body 2 having a through hole 22 with an internal thread 21, and a peripheral wall 21 formed on one side of the through hole 22; and a cap 3 fitted in the peripheral wall 23 of the nut body 2. A proximal part 24 is formed on a proximal end 23a of the peripheral wall 23. In the insert nut 1, the cap 3 is pressure-bonded and fixed between the proximal part 24 and the peripheral wall 23 through a part thereof that is bent inside the through hole 22. In the following description, parts of the second embodiment, which differ from those of the first embodiment, are mainly described. In the following description and the drawings used in the following description, the same reference numerals as those used for the corresponding parts in the first embodiment are used for parts that can be configured in the same way as in the first embodiment described above, and duplicate descriptions are omitted.

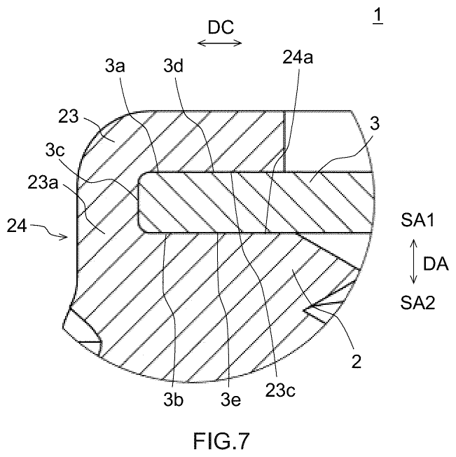

FIG. 7 is a partial sectional view showing in enlargement a part surrounded by a line indicated by a reference numeral VII in FIG. 6. As shown in FIG. 7 in the second embodiment, the peripheral wall 23 is pressure-bonded to the cap 3 such that a side surface 23 of the peripheral wall 23 is in contact with the cap 3. In the example shown in FIG. 7, since the peripheral wall 23 is bent at an angle of 90°, the peripheral wall 23 is pressure-bonded to the cap 3 such that the side surface 23 of the peripheral wall 23 is in contact with the cap 3. In particular, the peripheral wall 23 is pressure-bonded to the cap 3 such that the side surface 23 of the peripheral wall 23 is in contact with the cap 3, and that the side surface 23c of the peripheral wall 23 covers an entire circumference of an outer edge 3c of the cap 3.

According to the second embodiment, since the peripheral wall 23 is pressure-bonded to the cap 3 such that the side surface 23c of the peripheral wall 23 is in contact with the cap 3, one end of the through hole 22 can be stably sealed by the cap 3. Particularly in the second embodiment, the side surface 23c of the peripheral wall 23 is in surface contact with a first surface 3a of the cap 3. Thus, as compared with a case in which the peripheral wall 23 is pressure-boded to the cap 3 such that the distal end surface 23b of the peripheral wall 23 is in contact with the cap 3, an area where the surface of the peripheral wall 23 and the first surface 3a of the cap 3 are in contact with each other can be enlarged. Since the side surface 23c of the peripheral wall 23 and the first surface 3a of the cap 3 are in tight contact with each other over the larger contact area, the one end of the through hole 22 can be stably sealed. The second embodiment also applies a pressing force toward the second side SA1 can be applied from the peripheral wall 23 to the first surface 3a of the cap 3. Since the pressing force from the peripheral wall 23 allows a placement surface 24a of the proximal part 24 and a second surface 3b of the cap 3 to be in tight contact with each other, the one end of the through hole 22 can be stably sealed. This restricts a resin forming a resin molded product 7 from entering the through hole 22, when the resin molded product 7 in which the insert nut 1 is embedded is manufactured.

In addition, according to the second embodiment, the peripheral surface 23 is pressure-bonded to the cap 3 such that the side surface 23c of the peripheral wall 23 is in contact with the cap 3, and that the side surface 23c of the peripheral wall 23 covers the entire circumference of the outer edge 3c of the cap 3. This allows the side surface 23c of the peripheral wall 23 and the first surface 3a of the cap 3 to be tightly in contact with each other over the entire circumference of the outer edge 3c of the cap 3, whereby the one end of the through hole 22 can be stably sealed.

Next, modification examples of the aforementioned first embodiment and the second embodiment are described.

### FIRST MODIFICATION EXAMPLE

In the aforementioned first embodiment and the second embodiment, the example in which the contact part of the cap 3, which is in contact with the peripheral wall 23, and the contact part of the cap 3, which is in contact with the proximal part 24, are flat was described. In particular, the example in which the contact part of the cap 3, which is in contact with the peripheral wall 23, and the contact part of the cap 3, which is in contact with the proximal part 24, form flat surfaces perpendicular to the axial direction DA was described. However, forms of the cap 3, the peripheral wall 23 and the proximal part 24 are not limited thereto.

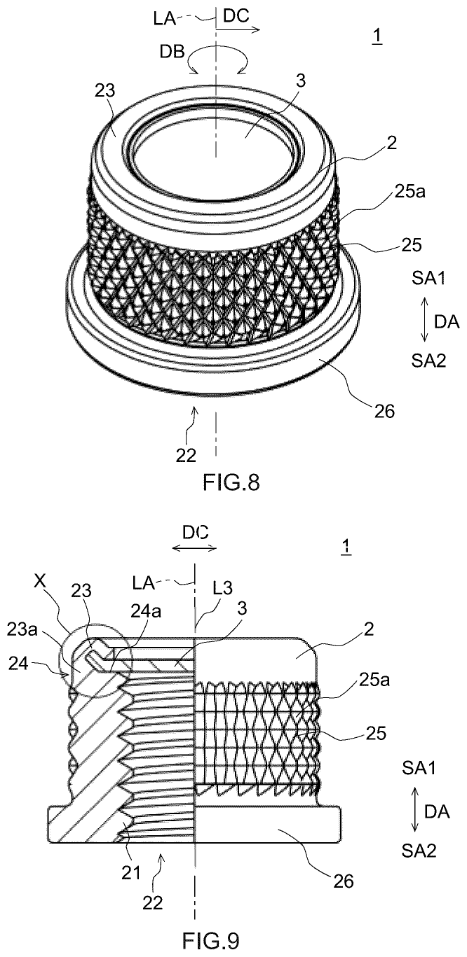

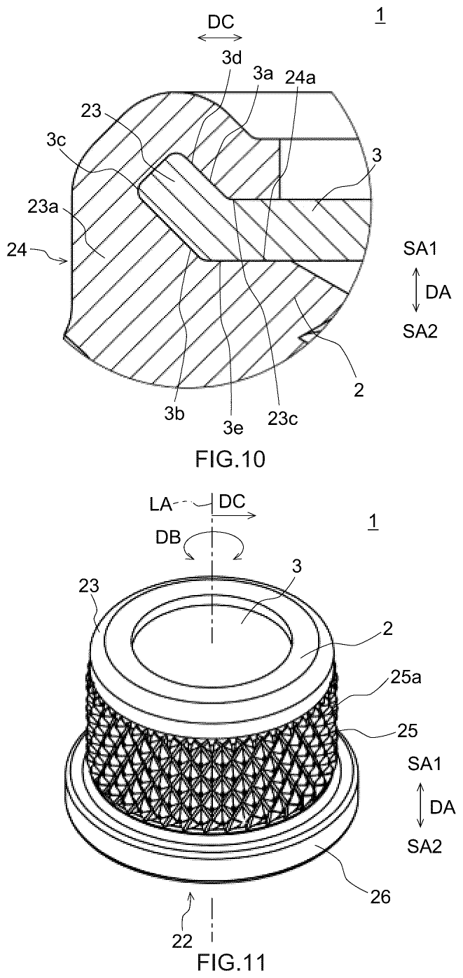

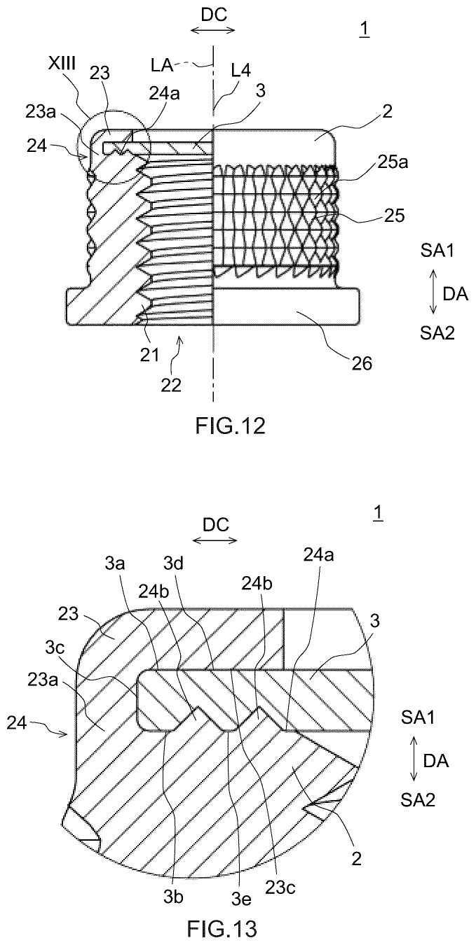

FIG. 8 is a perspective view showing an example of an inert nut 1 in a first modification example of the present disclosure. FIG. 9 is a side and sectional view of the insert nut 1 shown in FIG. 8. In FIG. 9, a right side of a line indicated by a reference numeral L3 shows a side view of a right half of the insert nut 1. A left side of the line indicated by the reference numeral L3 shows a sectional view of a left half of the insert nut 1. FIG. 10 is a partial sectional view showing in enlargement a part surrounded by a line indicated by a reference numeral X in FIG. 9. FIG. 11 is a perspective view of the insert nut 1 in the first modification example, showing an example different from FIG. 8. FIG. 12 is a side and sectional view of the insert nut 1 shown in FIG. 11. In FIG. 12, a right side of a line indicated by a reference numeral L4 shows a side view of a right half of the insert nut 1. A left side of the line indicated by the reference numeral L4 shows a sectional view of a left half of the insert nut 1. FIG. 13 is a partial sectional view showing in enlargement a part surrounded by a line indicated by a reference numeral XIII in FIG. 12. In the insert nut in the first modification example, similarly to the second embodiment, the peripheral wall 3 is pressure-boded to the cap 3 such that the side surface 23c is in contact with a cap 3. In the following description, parts of the first modification example, which differ from those of the second embodiment, are mainly described. In the following description and the drawings used in the following description, the same reference numerals as those used for the corresponding parts in the respective embodiments are used for parts that can be configured in the same way as in the respective embodiment described above, and duplicate descriptions are omitted.

In the insert nut 1 in the first modification example, at least any one of a contact part of the cap 3, which is in contact with the peripheral wall 23, and a contact part of the cap 3, which is in contact with the proximal part 24, is not flat but has a folded shape or an irregular shape. In addition, in the insert nut 1 in the first modification example, at least any one of the contact part of the cap 3, which is in contact with the peripheral wall 23, and the contact part of the cap 3, which is in contact with the proximal part 24, has an inclined surface inclined with respect to the axial direction DA.

In the insert nut 1 shown in FIGS. 8 to 10, each of the contact part of the cap 3, which is in contact with the peripheral wall 23, and the contact part of the cap 3, which is in contact with the proximal part 24, have a part that is inclined upward (first side SA1 in the axial direction DA) as it extends outside (outside in the radial direction DC). In the example shown in FIG. 10, both the contact part of the cap 3, which is in contact with the peripheral wall 23, and the contact part of the cap 3, which is in contact with the proximal part 24, have a folded shape. In the example shown in FIG. 10, each of a first cap contact surface 3d of the cap 3, which is in contact with the peripheral wall 23, and a second cap contact surface 3e of the cap 3, which is in contact with the proximal part 24, has a flat surface perpendicular to the axial direction DA, and an inclined surface that is inclined to the first side SA1 in the axial direction DA as it extends to the outside in the radial direction DC. The inclined surface of the first cap contact surface 3d surrounds the flat surface of the first cap contact surface 3d from the outside in the radial direction DC. The inclined surface of the second cap contact surface 3e also surrounds the flat surface of the second cap contact surface 3e from outside the radial direction DC.

In the insert nut 1 shown in FIGS. 11 to 13, a proximal part 24 has an irregular shape breaking into a cap 3. The insert nut 1 shown in FIG. 13 has a plurality of projections 24b in a contact part of the proximal part 24, which is in contact with a peripheral wall 23. By way of example, a plurality of the projections 24b respectively extend in the circumferential direction DB to form an annular shape. A plurality of the projections 24b may be spiral-shaped, spiraling around the axis line LA. In the example shown in FIG. 13, since the irregular shape of the proximal part 24 breaks into the cap 3, a part of the cap 3, which is in contact with the proximal part 24, also has an irregular shape. In the example shown in FIG. 13, the first cap contact surface 3d of the cap 3, which is in contact with the peripheral wall 23, partially has an irregular shape. The first cap contact surface 3d has an inclined surface partially inclined to the axial direction DA, in the part having the irregular shape.

Since at least any one of the contact part of the cap 3, which is in contact with the peripheral wall 23, and the contact part of the cap 3, which is in contact with the proximal part 24, has an inclined surface inclined to the axial direction DA, the insert nut 1 in the first modification example provides the following effect. When the contact part of the cap 3, which is in contact with the peripheral wall 23, has an inclined surface inclined to the axial direction DA, the first cap contact surface 3d can have a larger area as compared with a case in which the contact part of the cap 3, which is in contact with the peripheral wall 23, has only a surface perpendicular to the axial direction DA. When the contact part of the cap 3, which is in contact with the proximal part 24, has an inclined surface inclined to the axial direction DA, the second cap contact surface 3e can have a larger area as compared with a case in which the contact part of the cap 3, which is in contact with the proximal part 24, has only a surface perpendicular to the axial direction DA. Since the surface of the peripheral wall 23 and the first surface 3a of the cap 3 can be made in tight contact with each other over the larger area, or the placement surface 24a of the proximal part 24 and the second surface 3b of the cap 3 can be made in tight contact with each other over the larger area, one end of the through hole 22 can be stably sealed.

In particular, the insert nut shown in FIGS. 8 to 10 in which each of the contact part of the cap 3, which is in contact with the peripheral wall 23, and the contact part of the cap 3, which is in contact with the proximal part 24, have a part that is inclined upward as it extends to the outside provides the following effect. Since each of the first cap contact surface 3d and the second cap contact surface 3e has an inclined surface inclined to the axial direction DA, each of the first cap contact surface 3d and the second cap contact surface 3e can have a larger area as compared with a case in which each of the first cap contact surface 3d and the second cap contact surface 3e is a surface perpendicular to the axial direction DA. Thus, the surface of the peripheral wall 23 and the first surface 3a of the cap 3 can be made in tight contact with each other over the larger area, and the placement surface 24a of the proximal part 24 and the second surface 3b of the cap 3 can be made in tight contact with each other over the larger area. In addition, the cap 3 is difficult to be displaced in the circumferential direction DC with respect to the nut body 2. As a result, the one end of the through hole 22 can be more stably sealed.

The insert nut 1 shown in FIGS. 11 to 13 in which the proximal part 24 has an irregular shape breaking into the cap 3 provides the following effect. Since the irregular shape of the proximal part 24 breaks into the cap 3, the part of the proximal part 24, which has the irregular shape, and the cap 3 can be made in tight contact with each other more strongly. Particularly when the proximal part 24 has the projection 24b as shown in FIG. 13, the projections 24b of the proximal part 24 and the cap 3 can be made in tight contact with each other strongly. Since the first cap contact surface 3d partially has an irregular shape, the first cap contact surface 3d can have a larger area as compared with a case in which the first cap contact surface 3d is a surface perpendicular to the axial direction DA. Thus, the placement surface 24a of the proximal part 24 and the second surface 3b of the cap 3 can be made in tight contact with each other over the larger area. In addition, since the irregular shape of the proximal part 24 breaks into the cap 3, the cap 3 is difficult to be displaced in the circumferential direction DC with respect to the nut body 2. As a result, the one end of the through hole 22 can be more stably sealed.

In the first modification example a method of forming the folded shape, the irregular shape or the inclined surface inclined to the axial direction DA on at least any one of the contact part of the cap 3, which is in contact with the peripheral wall 23, and the contact part of the cap 3, which is in contact with the proximal part 24, is not particularly limited. The cap 3 having a desired folded shape, an irregular shape or an inclined surface maybe made first. Then, when the cap 3 is pressure-bonded and fixed between the proximal part 24 and the peripheral wall 23, the peripheral wall 23 and the proximal part 24 may be deformed to be in tight contact with a surface of the cap 3. Alternatively, the nut body 2 comprising the peripheral wall 23 and the proximal part 24 each having a desired folded shape, an irregular shape or an inclined surface may be made first. Then, when the cap 3 is pressure-bonded and fixed between the proximal part 24 and the peripheral wall 23, the cap 3 may be deformed to be in tight contact with the surfaces of the peripheral wall 23 and the proximal part 24. Yet alternatively, the cap 3 having a desired shape, and the nut body 2 comprising the peripheral wall 23 and the proximal part 24 each having a desired shape may be made. Then, the cap 3 having the desired shape maybe pressure-bonded and fixed between the proximal part 24 and the peripheral wall 23 of the nut body 2 each having the desired shape.

### SECOND MODIFICATION EXAMPLE

In the aforementioned first embodiment, the second embodiment and the first modification example, the example in which the cap 3 is a member made of a single material is described. However, the form of the cap 3 is not limited thereto.

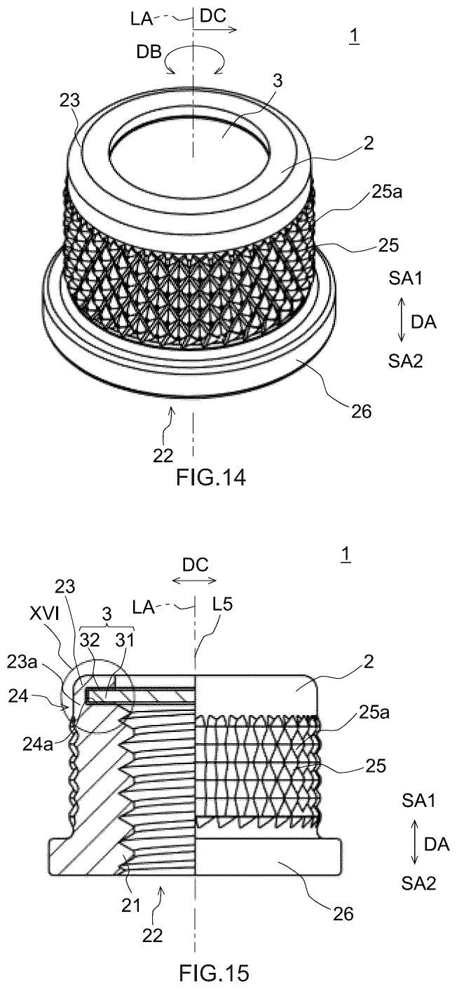

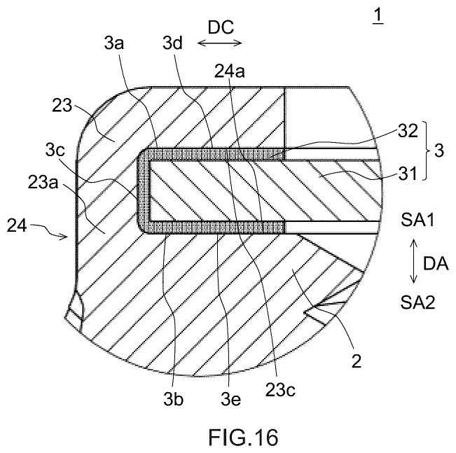

FIG. 14 is a perspective view of an insert nut 1 in a second modification example of the present disclosure. FIG. 15 is aside and sectional view of the insert nut shown in FIG. 14. In FIG. 15, a right side of a line indicated by a reference numeral L5 shows a side view of a right half of the insert nut 1. A left side of the line indicated by the reference numeral L5 shows a sectional view of a left half of the insert nut 1. FIG. 16 is a partial sectional view showing in enlargement a part surrounded by a line indicated by a reference numeral XVI in FIG. 15. In the insert nut in the second modification example, similarly to the second embodiment, the peripheral wall 3 is pressure-boded to the cap 3 such that the side surface 23c is in contact with a cap 3. In the following description, parts of the second modification example, which differ from those of the second embodiments and the first modification example, are mainly described. In the following description and the drawings used in the following description, the same reference numerals as those used for the corresponding parts in the respective embodiments and the first modification example are used for parts that can be configured in the same way as in the respective embodiment and the first modification example described above, and duplicate descriptions are omitted.

In the insert nut 1 in the second modification example shown in FIGS. 14 to 16, the cap 3 has a cap body 31, and a seal member 32 provided between the nut body 2 and the cap body 31. The cap 3 is in contact with the nut body 2 through the seal member 32.

The above description about the cap 3, which is a member made of a single material, in the respective embodiments and the first modification example can be applied to the description of the cap body 31 in the second modification example, as long as it is not contradictory thereto. For example, the cap body 31 may be made of stainless steel or aluminum alloy.

The seal member 32 is a member provided between the nut body 2 and the cap body 31. The seal member 32 may be positioned on the first side SA1 in the axial direction DA of the cap body 31, the second side SA1 in the axial direction DA of the cap body 31, or outside the radial direction DC of the cap body 31. In the example shown in FIG. 15 the seal member 32 covers a part of the cap body 31 on the first side SA1 in the axial direction DA, a part of the cap body 31 on the second direction SA1 in the axial direction DA, and an entire outside of the cap body 31 in the radial direction DC. In the example shown in FIG. 16, the seal member 32 is positioned between the peripheral wall 23 of the nut body 2 and the cap body 31, and between the proximal part 24 of the nut body 2 and the cap body 31.

The cap 3 is in contact with the nut body 2 through the seal member 32. In the example shown in FIG. 16, since the seal member 32 is provided between the nut body 2 and the cap body 31, the cap body 31 is not in contact with the nut body 2.

A material of the seal member 32 is suitably selected such that the seal member 32 located between the nut body 2 and the cap body 31 can restrict formation of a gap between the nut body 2 and the cap body 31. The material of the seal member 32 may be a metallic material or non-metallic material. From the viewpoint of restricting formation of a gap between the nut body 2 and the cap body 31, the material of the seal member 32 preferably has elasticity. Rubber can be the material of the seal member 32 having elasticity, for example.

The seal member 32 may be joined to the cap body 31 by an adhesive or the like or may not be joined to the cap body 31. The insert nut 1 in the second modification example can be manufactured by forming the cap 3 in which the cap body 31 and the seal member 32 are combined with each other, by placing the cap 3 on the placement surface 24a of the proximal part 24, and by pressure-bonding and fixing the cap 3 between the proximal part 24 and the peripheral part 23. Alternatively, the insert nut 1 in the second modification example can be manufactured by placing the seal member 32 on the placement surface 24a of the proximal part 24, by placing the cap body 31 further on the seal member 32 to form the cap 3, and by pressure-bonding and fixing the cap 3 between the proximal part 24 and the peripheral part 23.

In the insert nut 1 in the second modification example, the cap 3 has the cap body 31 and the seal member 32, and is in contact with the nut body 2 through the seal member 32. Thus, the seal member 32 can restrict formation of a gap between the nut body 2 and the lid body 31. In particular, since the seal member 32 is located between the peripheral wall 23 of the nut body 2 and the cap body 31, formation of a gap between the peripheral wall 23 and the cap body 31 can be restricted. Since the seal member is located between the proximal part 24 of the nut body 2 and the cap body 31, formation of a gap between the proximal part 24 and the cap body 31 can be restricted. In particular, by selecting a material that can restrict formation of a gap between the nut body 2 and the cap body 31 as the material of the seal member 32, formation of a gap between the nut body 2 and the cap body 31 can be more stably restricted. Thus, one end of the through hole 22 can be more stably sealed.

The aspect of the invention is not limited to the above-described embodiments, but includes various variations that can be conceived by those skilled in the art, and the effects of the invention are not limited to the above-described contents. In other words, various additions, modifications, and partial deletions are possible without departing from the conceptual idea and purpose of the invention derived from the contents and equivalents specified in the claims.
1 Insert nut
2 Nut body
21 Internal thread
22 Through hole
23 Peripheral wall
23a Proximal end
23b Distal end surface
23c Side surface
24 Proximal part
3 Cap
3c Outer edge
31 Cap body
32 Seal member
7 Resin molded product

What is claimed is:

1. An insert nut to be embedded in a resin molded product, the insert nut comprising:
a nut body having a through hole with an internal thread, and a peripheral wall formed on one side of the through hole; and
a cap fitted in the peripheral wall of the nut body;
wherein:
a proximal part is formed on a proximal end of the peripheral wall of the nut body;
the cap is pressure-bonded and fixed between the proximal part and the peripheral wall through a part thereof that is bent inside the through hole;
and
the peripheral wall is pressure-bonded to the cap such that a distal end surface of the peripheral wall is in contact with the cap.

2. An insert nut to be embedded in a resin molded product, the insert nut comprising:
a nut body having a through hole with an internal thread, and a peripheral wall formed on one side of the through hole; and
a cap fitted in the peripheral wall of the nut body;
wherein:
a proximal part is formed on a proximal end of the peripheral wall of the nut body;
the cap is pressure-bonded and fixed between the proximal part and the peripheral wall through a part thereof that is bent inside the through hole;
and
the peripheral wall is pressure-bonded to the cap such that a side surface of the peripheral wall is in contact with the cap.

3. The insert nut according to claim 1, wherein
the peripheral wall is pressure-bonded to the cap to cover an entire circumference of an outer edge of the cap.

4. The insert nut according to claim 2, wherein
the peripheral wall is pressure-bonded to the cap to cover an entire circumference of an outer edge of the cap.

5. The insert nut according to claim 1, wherein
each of a contact part of the cap, which is in contact with the peripheral wall, and a contact part of the cap, which is in contact with the proximal part, has a part that is inclined upward as it extends outside.

6. The insert nut according to claim 2, wherein
each of a contact part of the cap, which is in contact with the peripheral wall, and a contact part of the cap, which is in contact with the proximal part, has a part that is inclined upward as it extends outside.

7. The insert nut according to claim 1, wherein
the proximal part has an irregular shape breaking into the cap.

8. The insert nut according to claim 2, wherein
the proximal part has an irregular shape breaking into the cap.

9. The insert nut according to claim 1, wherein:
the cap has a cap body, and a seal member provided between the nut body and the cap body; and
the cap is in contact with the nut body through the seal member.

10. The insert nut according to claim 2, wherein:
the cap has a cap body, and a seal member provided between the nut body and the cap body; and
the cap is in contact with the nut body through the seal member.

11. The insert nut according to claim 1, wherein
the nut body is made of carbon steel and is plated with zinc, or is made of stainless steel.

12. The insert nut according to claim 2, wherein
the nut body is made of carbon steel and is plated with zinc, or is made of stainless steel.

13. The insert nut according to claim 1, wherein
the cap body is made of stainless steel or aluminum alloy.

14. The insert nut according to claim 2, wherein
the cap body is made of stainless steel or aluminum alloy.
